(19) United States
(12) Patent Application Publication
(10) Pub. No.: US 2008/0021918 A1
(43) Pub. Date: Jan. 24, 2008

(54) Enterprise service management unifier system

(76) Inventor: Viswanatha Hemoji Rao, Houston, TX (US)

Correspondence Address: Viswanatha Rao, 11202 Hillside Glen Trl, Houston, TX, 77065, US

(21) Appl. No.: 11/644,457

(22) Filed: Dec. 22, 2006

Related U.S. Application Data
(60) Provisional application No. 60/753,814, filed on Dec. 23, 2005.

(51) Int. Cl. G06F 15/173; G06F 17/30

(52) U.S. Cl. 707/102; 709/223; 707/E17.009

(57) ABSTRACT

The invention is directed to an architecture and method for managing multiple resources and services in an Information Technology (IT) environment. The invention particularly provides an enterprise service management unifier system for leveraging and unifying heterogeneous IT resource management systems and their services offered by multiple vendors. The system architecture provides web services based communication framework for one or more producers to publish resource management capabilities as services and one or more consumers to avail published services. The framework consists of service negotiation and customization stacks to discover, negotiate, customize, and manage services based on service level agreements mutually acceptable between producer and consumer. Layered stacks allow state persistence with additional flexibility to reengineer services in modular fashion. The method includes steps to build consumer services by accessing one or more producer services, grouping producer managed resources into logical service channels, customizing channel resource parameters, and aggregating channels into enterprise IT services. Method also includes techniques to inspect events generated by producer service(s), correlate events based on rules, and forward events to appropriate users and enterprise service components.

### CROSS-REFERENCE TO RELATED APPLICATIONS

This application claims the benefit of provisional patent application No. 60/753,814 filed Dec. 23, 2005 by the present inventor.

### FEDERALLY SPONSORED RESEARCH

Not applicable

### SEQUENCE LISTING OR PROGRAM

A program listing is provided as computer program listing on two compact discs (CD-R) both containing same file with following details.

Filename: Pws_HostLayer_SLC.txt

File size: 8.29 KB (8,494 bytes)

File Creation date: Dec. 22, 2006

### BACKGROUND

1. Field of the Invention

The present invention relates generally to the IT resource management environment, where an IT resource may be a device, an application, or a service. Particularly, the invention relates to unifying services from heterogeneous management systems into an interoperable service.

2. Prior Art

Enterprise IT resources are managed by either device or application specific IT resource management systems. These diverse management systems are mostly proprietary in nature and hardly interoperate with each other. Even in cases where third party vendors provide interoperable solutions, they often fail when resource vendors change underlying agent software versions. Currently, an IT service is a vendor specific management solution, instead of being a service customizable by end users and interoperable between other solutions. For instance, management systems like Microsoft Management Console operate only on Windows platforms, where as, enterprises are in need of cross-platform IT services. Yet another instance, an enterprise may have both Microsoft Windows and UNIX based storage devices that need to be customized and managed as a single cross-platform storage service.

An IT resource management system has to monitor and report resource performance via events. To assess the actual impact of these events, administrators have to correlate events manually across different systems. Also, when IT executives need a summary of performance status, administrators lack proper tools to correlate events from various services and systems. An interoperable cross platform solution will have to correlate events from diverse resources and services to determine which resource or service exactly impacts the dependent service and how it affects its objectives.

Corporate customers therefore need a framework that allows computer programs to interoperate across diverse IT resource management systems. Extensible Markup Language (XML) based web services provide an open platform, on which services can electronically exchange service requirements and resource capabilities across heterogeneous systems. A XML web service based solution can simplify heterogeneous resource management into homogenous service management where administrators can build and deploy IT services. This service-centric approach reduces the complexity of managing several hundred(s) of resources and associated variables to a handful of customizable services, reducing operational time and costs while enhancing the quality of service. There is a huge market for an enterprise service management application that can drive an automated set of processes and workflows on an open web service framework, to manage IT services customized across diverse resources, participating users, and available services.

### SUMMARY

The present invention provides an architecture and method for an enterprise service management unifier system. The architecture consists of web services communicating between a consumer and one or more producers, to create an IT service that leverages producer's IT resource capabilities. An IT resource may represent an IT device, or an IT application, or an IT service. IT resource management vendors acting as producers, manage resources via Producer Web Services (PWS). Enterprise administrators as consumers, access PWS via Consumer Web Services (CWS). Both PWS and CWS communicate via web services between two computer systems.

PWS exposes its capabilities to manage discovery, configuration, provisioning, and performance monitoring of resources, over different layers. The layered capabilities are published as web service documents that can be discovered by CWS via web services. CWS can select desired resources from one or more PWS and aggregate them into an IT channel, a logical service element. CWS can further negotiate service contracts for an IT channel from a peer PWS. The negotiated channel can be further customized to reflect consumer preferences. Fully customized channels can be aggregated and deployed as enterprise IT services. PWS monitors the resources to ensure each of the resources provide necessary behavior to meet negotiated service contracts. When a service contract is not honored, resources and or their monitoring systems may generate events. The events are processed and forwarded from resource through PWS and CWS, all the way to the target users and services.

Administrators can create brand new services or reengineer existing services by accessing a web user Interface (UI). Administrators mediate service negotiation to conclude Service Level Agreements (SLA) between consumer and producers. Administrators retain full control in configuring SLAs that fulfill their business needs, instead of choosing out of the box SLAs provided by producers. Further administrators can choose resources from diverse management systems, build a service across chosen resources, and manage the service from web UI, thereby achieving cross-platform interoperability.

As can be appreciated, with a layered approach for discovering, configuring, provisioning, monitoring, and correlating events from diverse management systems via an open web service framework, both producers and consumers get the flexibility to customize services, achieving interoperability. Consumers can reengineer a service by negotiating service contracts only for those layers that have been modified by the producer, without affecting other service layers, achieving maintainability. Differentiating service contracts by version number provides flexibility to switch a service back to older working version in case a new version fails, achieving fault tolerance. As additional producers and resources are added to the infrastructure, the enterprise IT service can aggregate those additions in a seamless manner, which improves scalability. The end-to-end service management unifier system described by this invention is positioned in a lucratively growing IT service(s) market to ensure long term viability.

### DRAWINGS

FIG. 1 illustrates a block diagram of an exemplary distributed enterprise network system in which the present invention is being utilized;

FIG. 2 illustrates a block diagram of an exemplary enterprise IT service framework, as defined and utilized by this invention;

FIG. 3 illustrates a block diagram of a typical enterprise infrastructure in which enterprise service management unifier system will operate;

FIGS. 4A and 4B are block diagrams illustrating an exemplary method of configuring consumer and producer portals of the enterprise service management unifier system;

FIG. 5 is a block diagram illustrating web service communication components of Consumer Service Manager and Producer Service Manager;

FIG. 6 illustrates the structural design of an XML schema for the host layer of producer's service negotiation stack;

FIGS. 7A and 7B are block diagrams illustrating steps to validate XML data and generate unique path identifiers;

FIGS. 8A and 8B are block diagrams illustrating the methods for publishing layer specific web services;

FIG. 9 is a sequence diagram illustrating an exemplary method of step by step communication between peer to peer layers of consumer and producer service negotiation stacks;

FIG. 10 is a block diagram illustrating the steps for creating a customized IT service;

FIGS. 11A, 11B, and 11C are block diagrams illustrating an exemplary method of configuring IT service elements of an enterprise IT Service;

FIGS. 12A and 12B are block diagrams illustrating the components of an event manager and its typical configuration;

FIG. 13 is block diagram illustrating an exemplary method of processing an event received by a portal;

FIG. 14 is a block diagram illustrating an exemplary method of managing events with dependencies.

### DETAILED DESCRIPTION

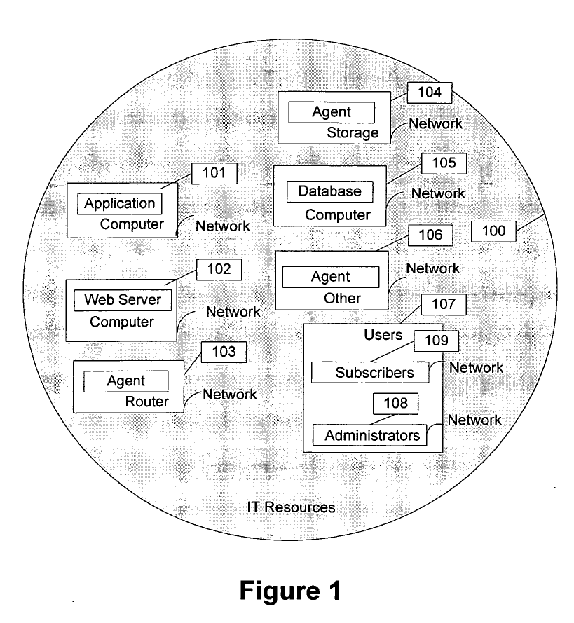

FIG. 1 illustrates a block diagram of an exemplary distributed enterprise network system in which the present invention is being utilized. The network system 100 may consist of IT resources: application computer 101, web server 102, router 103, storage device 104, and database 105. Examples of other devices 106 include but are not limited to tape libraries, printers, and workstations. The purpose of enterprise IT resources is to offer IT services to users. The users 107 may consist of administrators 108 and subscribers 109 accessing the services over the network 100 from their computers.

The services offered by IT management systems in an enterprise network are not interoperable, which drives a need for a new vendor neutral architecture for enterprise services. These IT services need a unifying framework where resources and services from multiple vendor systems can work seamlessly together.

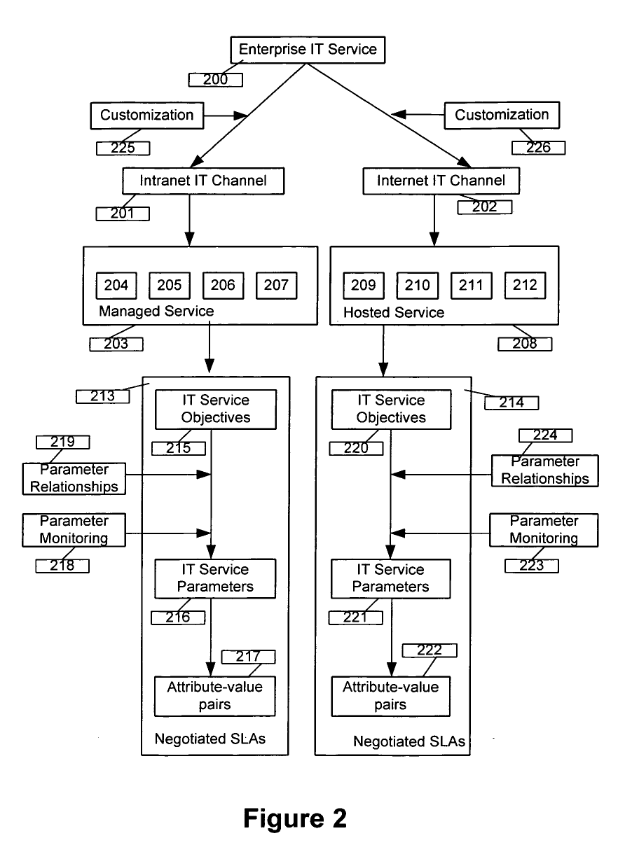

FIG. 2 illustrates a block diagram of an exemplary enterprise IT service framework, as defined and utilized by this invention. A vendor neutral enterprise IT service is an aggregation of one or more subordinate services termed as IT channels in this invention. An IT channel may be either a managed service leveraging a group of devices and applications or a hosted service from a vendor. For instance, an enterprise IT service 200 for managing web applications may aggregate two IT channels: intranet IT channel 201 and internet IT channel 202. The intranet channel 201 may be created by leveraging a managed service 203 managing resources: CISCO router 204, with Microsoft Internet Information Web Server 205, a Microsoft.NET web application 206, and a backend Microsoft SQL database 207. The internet IT channel 202 may be an externally hosted service 208 managing CISCO router 209, Apache web server from open source foundation 210, a Java web application 211, and an Oracle database 212. The management systems 203, 208 serve as producers, fulfilling the needs of consumer IT Channels 201, 202 respectively. The IT channels may electronically negotiate their service requirements vis-à-vis service capabilities offered by producers to define mutually acceptable Service Level Agreements (SLAs). The SLAs encompass a number of IT functions such as configuration, user access, security, provisioning, scheduling, monitoring IT parameters, as well as any other features supported by a managed or a hosted service. Internet Channel SLA 213 applies to specific service objectives 215, where each service objective covers chosen resource-specific IT parameters 216, which are configured by attributes and values 217, and monitored by specific conditions and events 218. Some of the chosen IT parameters may be interconnected by user defined rules to create parameter relationships 219. The parameter relationships provide additional flexibility to spread SLA across multiple service objectives. Internet Channel SLA 214 applies to specific service objectives 220, where each service objective covers chosen resource-specific IT parameters 221, which are configured by attributes and values 222 and monitored by specific conditions and events 223. The parameter relationships 224 provide additional flexibility to spread SLA across multiple service objectives. The negotiated SLAs of IT channels may be further customized by the enterprise policies. Customized policies 225, 226 include options such as user access, administrator access, secure authentication, schedules, costs, locations, and participating producers. The policies also include other business specific or administrator desired rules and preferences. The various components of IT service framework shown by FIG. 2 are collectively referred to as IT service elements. For example, an IT channel is a service component and its instance, an Internet IT Channel, is an IT service element. Likewise, a resource is a service component and its instance, a CISCO Router, is an IT service element. In the same way, an IT parameter is a service component and its instance, a Computer Physical Memory, is an IT service element.

Referring to same FIG. 2, an enterprise IT service can be reengineered at different levels. For instance, an enterprise IT service may be reconfigured by adding a new channel or removing an existing channel. A channel structure may be changed by regrouping resources. A channel structure may be reconfigured by negotiating a new set of service objectives or customizing it with new policies or preferences. This embodiment of an exemplary framework for building and reengineering a customizable vendor neutral IT service, leveraged across diverse management systems, may be implemented by the enterprise service management unifier system, as described by this invention.

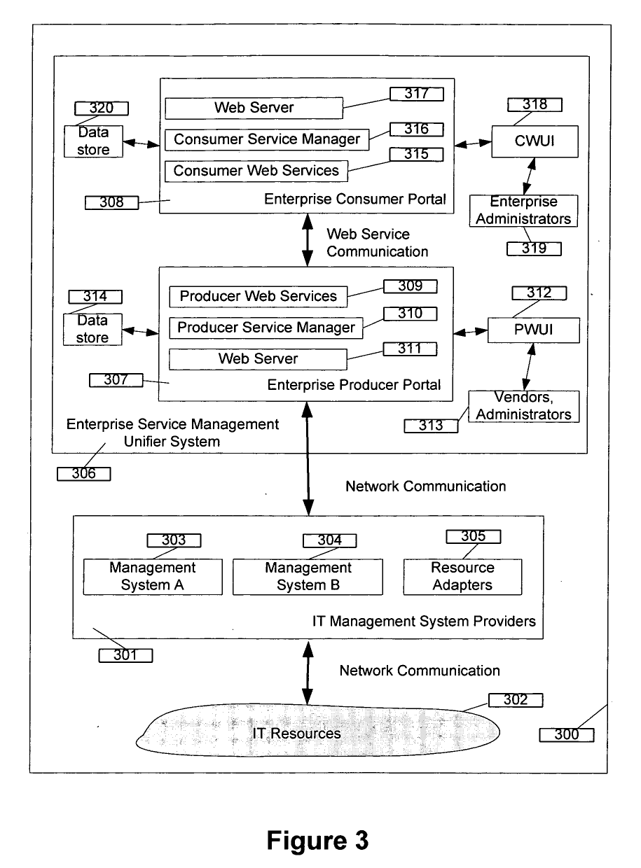

FIG. 3 illustrates a block diagram of a typical enterprise infrastructure in which enterprise service management unifier system will operate. The enterprise infrastructure 300 may have a group of IT management system providers 301 representing vendor specific Management System A 303, Management System B 304 and third party resource adapters 305. The management systems may manage resources using Simple Network Management Protocol (SNMP) or some other proprietary protocol by communicating with resources 302.

Referring to same FIG. 3, the invention creates an enterprise service management unifier system 306 comprising of two portals: Enterprise Producer Portal (EPP) 307 and Enterprise Consumer Portal (ECP) 308. EPP is a computer that supports Producer Web Services (PWS) 309 and a Producer Service Manager (PSM) application 310 via Internet Web Server 311. PWS represents web based services for an IT management system functioning as a producer. EPP is accessed and managed over the web via the Producer Web User Interface (PWUI) 312 residing on EPP or some other computer. Vendor representatives or enterprise administrators 313 can access and manage the portal via PWUI Web pages. The application data related to EPP is stored in a data store 314 residing on EPP or some other computer.

ECP is a computer that supports Consumer Web Services (CWS) 315 and a Consumer Service Manager (CSM) application 316, via Internet Web Server 317. CWS represents web services for enterprise IT services functioning as a consumer. ECP is accessed over the web via Consumer Web User Interface (CWUI) 318 residing on ECP or some other computer. Enterprise administrators 319 configure, provision, and subscribe to IT Services via CWUI Web pages. The application data related to ECP is stored in a database 320 residing on ECP or some other computer. The CWS and PWS will communicate via web services, conforming to the standards developed by World Wide Web (W3) Consortium.

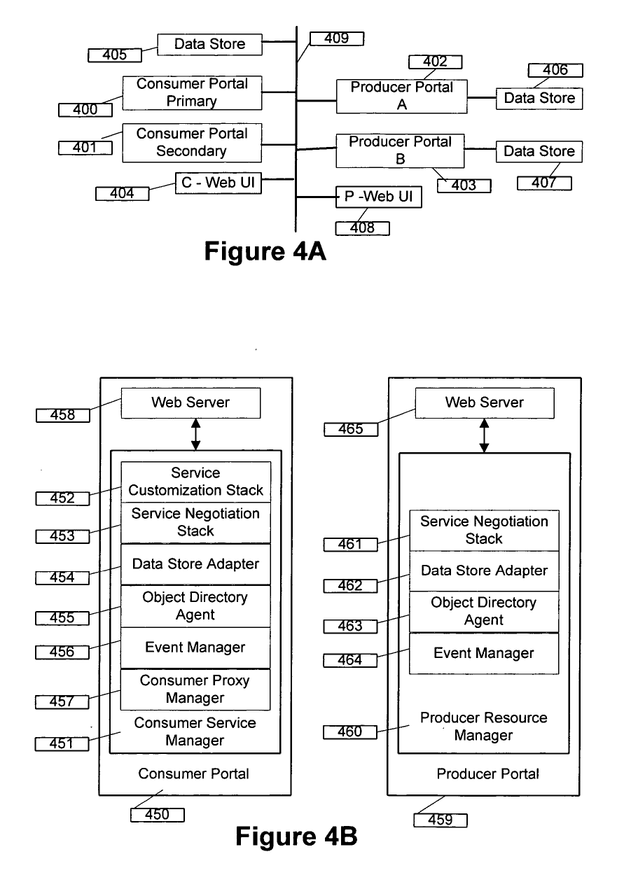

FIGS. 4A and 4B are block diagrams illustrating an exemplary method of configuring consumer and producer portals of the enterprise service management unifier system. Referring to FIG. 4A, Consumer Portal Primary 400 is configured to run on a computer and Consumer Portal Secondary 401 is configured to run on another computer. Under normal circumstances, the operational configuration indicates Consumer Portal Primary 400 is in active mode and Consumer Portal Secondary 401 is in standby mode, ready for activation. If Primary Portal 400 fails, the operational configuration is switched from primary to secondary and Secondary Portal 401 becomes active. When the Primary Portal is ready for operation, operational configuration is switched back from secondary to primary. The scripts required to synchronize and switch Portals back and forth are related to this invention.

Referring to same FIG. 4A, Consumer Portals 400 and 401 are identically configured, details shown in block 450 of FIG. 4B. Referring FIG. 4B, Consumer Portal 450 is configured with a consumer service manager 451 consisting of a Service Customization Stack 452, Service Negotiation Stack 453, Data Store Adapter 454, Object Directory Agent 455, an Event Manager 456, and Consumer Proxy Manager 457. The portal is also configured with a web server 458.

Referring to FIG. 4A, the enterprise may have one or more IT management systems functioning as producers. The management systems may be offered by one or more vendors. In the diagram, two such management systems are configured as Producer Portal A 402 and as Producer Portal B 403. Referring to FIG. 4B, typical Producer Portal configuration details are shown by Block 459. Each Producer Portal is configured with a producer service manager 460 consisting of Service Negotiation Stack 461, Data store Adapter 462, Object Directory Agent 463, and Event Manager 464. The Portal is also configured with a web server 465.

Referring to FIG. 4A, Consumer Portals 400 and 401 are identically configured with a Consumer Web UI 404 and data store 405. Producer Portal 402 is configured with data store 406 and Producer Portal 403 is configured with data store 407. Both Producer Portals 402 and 403 are configured with a web UI 408 providing authenticated access to each Producer Portal separately.

Consumer Portal Primary 400, Consumer Portal Secondary 401, Consumer web UI 404, data store 405, Producer Portal A 402, Producer Portal B 403, data store 406, data store 407, and Producer web UI 408 are interconnected via network 409. The network configuration may vary based on the enterprise needs. In one scenario, consumer portals along with their data store and web UI may be in one sub network and producer portals along with data stores and web UI may be on another subnet work, both situated within same intranet. In another scenario, when producer portals are offering hosted services, they may be outside an enterprise firewall and router. In yet another scenario, the consumer portals may reside in one location and the producer portals may reside in some other location both interconnected via the Internet protected by firewalls and routers. In another case, the Primary Secondary Portals of producer and consumer may be situated in different locations to ensure reliability.

The Consumer Service Manager (CSM) and Producer Service Manager (PSM) communicate via web services. PSM supports web services by publishing web service documents. The CSM, as a client, communicates with the PSM by creating proxies to producer web services. The proxies are created and maintained by the Consumer Proxy Manager. Apart from proxies, the CSM also supports consumer web services. One or more web based consumer UIs communicate as clients to the CSM by creating proxies to consumer web services. The purpose is to electronically exchange consumer requirements and producer capabilities to negotiate a mutually acceptable Service Level Agreement.

The data exchange is done in terms of data structures representing different data types. To achieve true interoperability, the consumer web UI, CSM, and PSM should know the exact format of exchanged data types. W3C standards provide XML Schemas as a means to define the structure and content of data types exchanged via web services. W3C defines some standard XML Schema data types but also allows user definition of additional complex data types. This invention creates the complex XML schema data types required to represent the service elements of IT service framework. The structure of XML schemas for use and customization by producer web services and by consumer web services is covered by this invention.

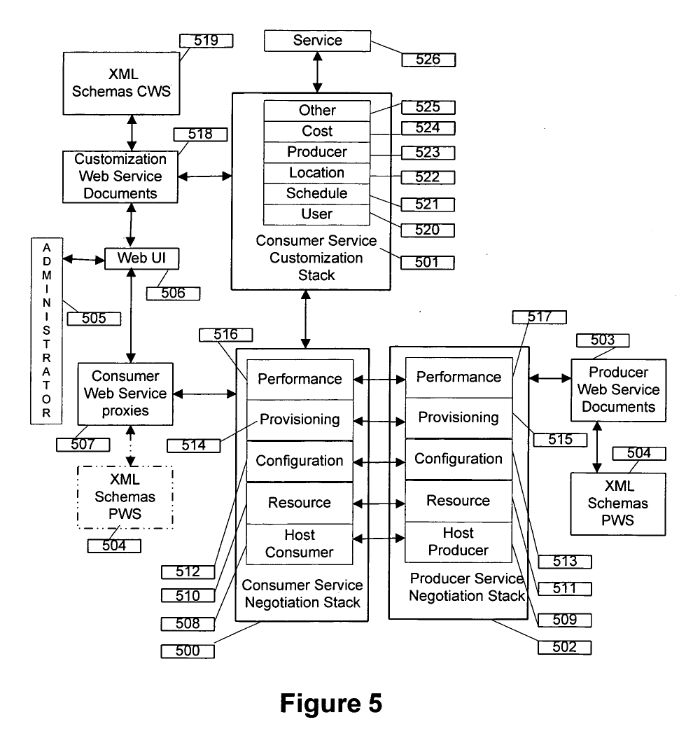

FIG. 5 is a block diagram illustrating web service communication components of Consumer Service Manager and-Producer Service Manager. The Consumer Service Manager (CSM) consists of a consumer service negotiation stack 500 and a consumer service customization stack 501. The Producer Service Manager (PSM) consists of service negotiation stack 502. Each service negotiation stack is shown to consist of five layers. The communication between stacks is restricted between peer to peer layers only. The producer exposes layer specific functionalities as web services by publishing producer web service documents 503 conforming to XML Schema for producer web services 504. The producer may customize the Schema to reflect layer specific management capabilities. The PWS is invoked by consumer proxies 507 for communication. The data received through proxy is validated with the XML Schema of producer web services 504. Next, the data is reviewed by the enterprise administrator 505 via web UI 506 on behalf of consumer negotiation stack 500. The choices and preferences of the administrator are transmitted via web service proxies to the producer negotiation stack. Both stacks communicate back and forth by exchanging requirements and capabilities until the enterprise administrator approves requirements vis-à-vis capabilities as acceptable SLA for peer to peer consumer and producer layers. As shown, the producer and consumer can have up to five SLAs for a given instance of IT service, one for each layer. However, more layers can be added to these consumer and producer negotiation stacks to support additional service negotiation features.

Referring to the same FIG. 5, Host consumer layer 508 gets producer details from its peer host producer layer 509. Consumer resource layer 510 picks resources from a list of managed resources, already published by producer resource layer 511. Next, consumer configuration layer 512 creates an IT channel, aggregates chosen resources into IT channel, and chooses resource specific IT parameters that it is interested in, by communicating with its peer producer configuration layer 513. Next, consumer provisioning layer 514 provisions selected IT parameters, with a set of attributes having default or administrator specified values or range of values, by communicating with its peer producer provisioning layer 515. Next, Consumer performance layer 516 configures conditions and actions for monitoring resource parameters, by communicating with its peer producer performance layer 517. For each of these layers, the service stacks keep negotiating until the administrator decides to accept the negotiated information as SLAs. The administrator may choose to abandon the negotiated values temporarily until he or she decides to pursue them at a later time, in which case the layer status is set to a state such as NEGOTIATION_PENDING. Also the administrator may want to stop the negotiation because he or she finds that the producer capabilities fail to meet the enterprise requirements. The enterprise may want to renegotiate their business agreements with the producer to get modified version of service capabilities that truly fulfills the enterprise requirements. Except for the business negotiation process, all other activities, such as maintaining a chronological state of what transpired during the web service negotiation process, may be recorded in a data store and such features may also be covered by this invention. The administrator approves the negotiated details as an SLA, which is then stored in data stores of both producer and consumer portals via Data Store Adapters.

Referring to the same FIG. 5, the IT channel negotiated between service negotiation stacks is further customized via the Service Customization Stack 501 supporting web services for service customization. The service customization capabilities are exposed as web services by publishing customization web service documents 518 conforming to the XML Schema for consumer web services 519. The web services are supported for each layer of the customization stack. Web UI 506 creates proxies to customization web services. Administrator 505 communicates via web UI to access consumer web services and perform customization of IT channels at each layer.

Referring to same FIG. 5, User layer 520 provides features to map enterprise administrators, subscribing users, authentication, and authorization rules to the negotiated IT channel. Schedule layer 521 provides features to map usage schedules. Location layer 522 provides features to map resource locations to the IT Channel. Producer layer 523 provides features to map a consumer to multiple producers. Cost layer 524 provides features to track channel specific negotiation costs, deployment costs, operating costs, and dismantling costs. Other layer 525 represents any other layers that may be added to the customization stack. Service layer 526 provides features to aggregate one or more customized IT channels into a unified enterprise service. The negotiation and customization features are not limited to the discussion presented in this invention, but may include additional features to meet the evolving needs of enterprise customers.

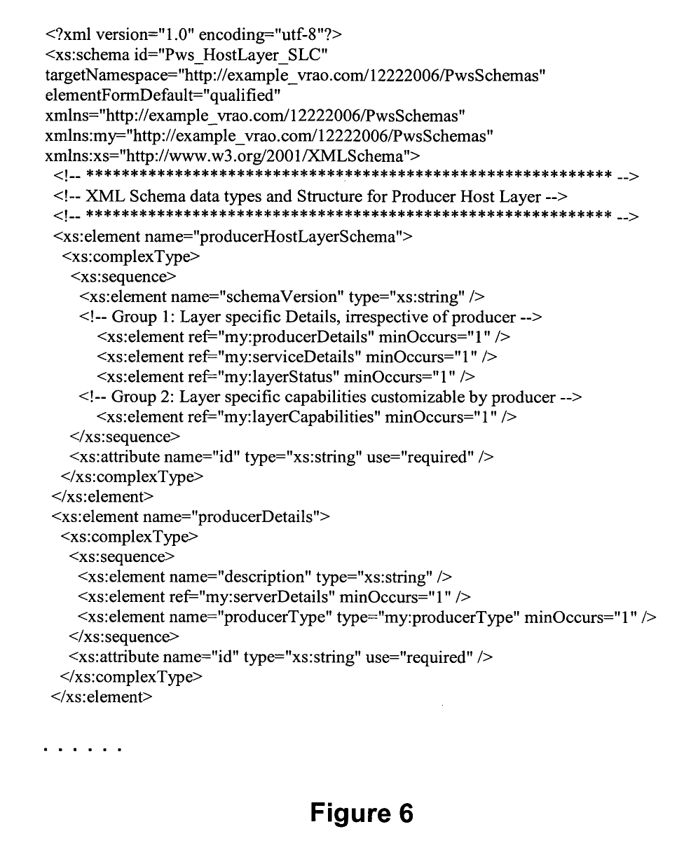

FIG. 6 illustrates the structural design of an XML schema for the host layer of producer's service negotiation stack. The contents of the schema fall into two groups. Group1 consists of data types that describe the host layer. In this instance, the major data types under group 1 are schemaVersion, producerDetails, serviceDetails, and layerStatus. Group 2 consists of data types that describe host layer service capabilities that can be further customized by the producer. In this instance, the major data type under group 2 is layerCapabilities.

Referring to same FIG. 6 again, the schemaVersion is a simple data type, unique to the XML schema and changes when the producer modifies the schema. The producerDetails is a complex data type that consists of a producer's unique ID, producer description, server details, producer type, and other relevant details. The serverDetails is a complex data type that consists of the Internet Protocol Addresses of primary and secondary producer servers and the mode. The mode suggests whether the producer is operating on its primary or secondary server. The producerType is a complex data type that describes the type or producer. Thr serviceDetails data type describes type of service and maximum duration for which the service is available from or licensed by from the producer. The layerStatus is a complex data type that indicates whether the layer is listening, down, negotiable, nonNegotiable, underNegotiation, or in any other type of status. The layercapabilities is a complex data type that exposes the service capabilities of the host layer through a combination of IT service elements. Further special properties indicate whether the IT service elements are negotiable or otherwise by the consumer.

The structural design of the XML schema described by this invention has several advantages. The uniqueness of the schema for each layer provides modularity and flexibility in building new services or reengineering existing services for both consumer and producer. The customizability of the schema provides a wide scope for vendors to offer unique services to consumers. The unique data types of the schema common to a layer irrespective of producer, ensures interoperability of service between diverse vendor management systems.

Producers and consumers transmit data conforming to these layer specific XML schemas. The data transmitted as XML messages via web services are read and manipulated with an XML parser. When a consumer is interoperating with multiple producers, it is possible that more than one XML node has same name, data type, and value. The present invention solves such conflicts by creating unique path identifiers for each node.

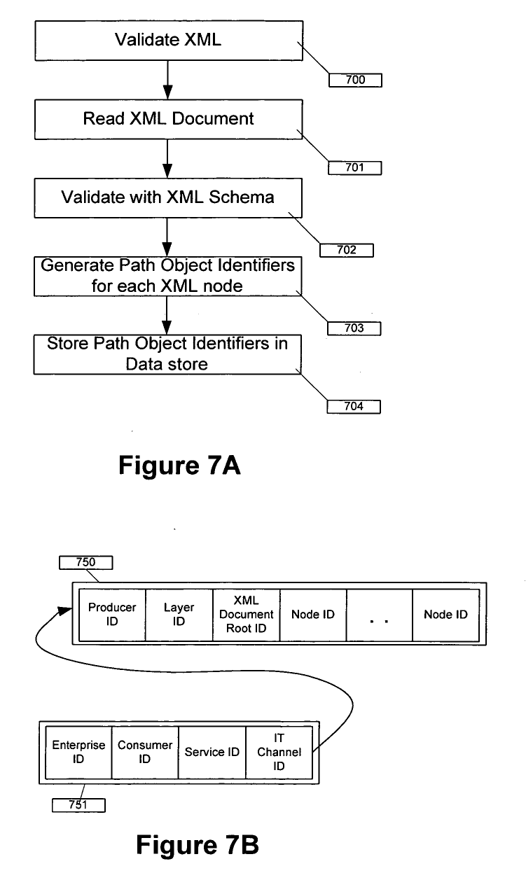

FIGS. 7A and 7B are block diagrams illustrating steps to validate XML data and generate unique path identifiers. Referring to FIG. 7A, validating XML data 700 for a specific negotiation or customization stack layer is accomplished by first reading XML document 701 that contains layer specific details. Next, document is validated with corresponding XML Schema 702. Then, the validated document is processed by Object Directory Agent which generates XML path identifiers for each node of XML document 703. Next, the nodes and corresponding path identifiers are stored in data store 704. XML data is validated whenever data is received by either the producer or consumer layer.

FIG. 7B shows a unique path identifier 750 for a XML node. In this instance, the XML node is an IT service element representing the Virtual Memory of a Web Server. The path identifier is generated by the producer's Object Identifier Agent. The path identifier consists of a producer ID, a unique identifier for the producer, followed by a layer ID to which the XML document belongs to, followed by the XML document root ID, followed by the IDs of all intermediate nodes leading to the node ID of Virtual Memory element.

When the consumer receives the XML document from the producer, it remaps the unique path identifier of Virtual Memory to its own domain. The remapping is done by the consumer Object Directory Agent by prefixing the path identifier with channel ID, service ID, consumer ID and enterprise ID as shown by block 751. The remapped path identifier is stored in consumer data store. When the consumer communicates Virtual Memory information back to the producer, it looks up the producer ID from its path identifier and sends the information to the right producer. The method for creating unique path identifiers for XML document nodes sharing path identifiers between domains, remapping path identifiers from one domain to another, and storing and retrieving identifiers from to data stores is related to this invention.

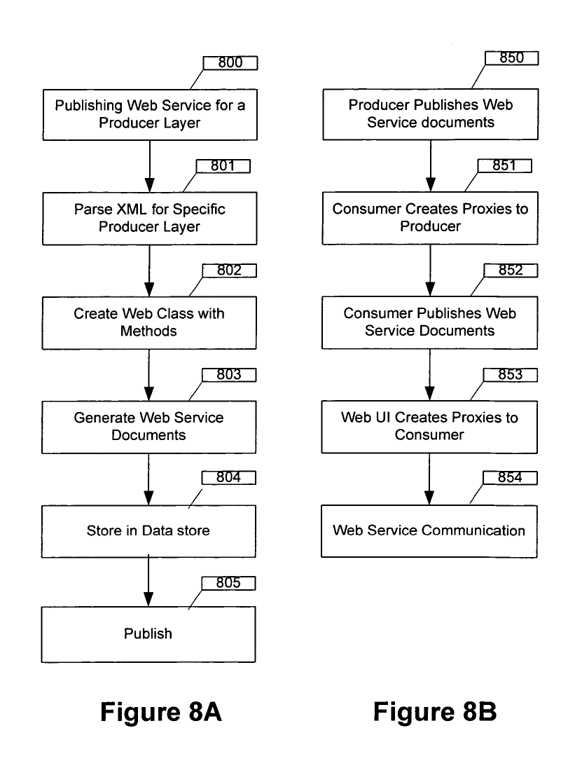

FIGS. 8A and 8B are block diagrams illustrating the methods for publishing layer specific web services. FIG. 8A is block diagram, illustrating a method of publishing web services for a producer's service negotiation stack layer. Publishing web service 800 consists of parsing layer specific XML document 801, as explained while referring to FIGS. 7A and 7B. Next, a web service class 802 is generated. The web service class describes methods for transferring XML data via web services. Next, web service documents 803 are generated. Then, the web service documents are stored in data store 804, and published 805 by providing the URL path to the web service document.

FIG. 8B is block diagram, illustrating a sequence of publishing web services required for end to end communication. The web service classes and web service documents for each layer of service negotiation stack are published by the producer 850. The consumer creates proxies 851 to the producer published documents using a web service definition language compiler. Next, the consumer creates web service classes and publishes web service documents 852 for each of the layers of service customization stack. Next, web UI creates proxies 853 to consumer published customization web service documents. The sequence completes an end to end web service communication framework 854 from web UI to producer via consumer.

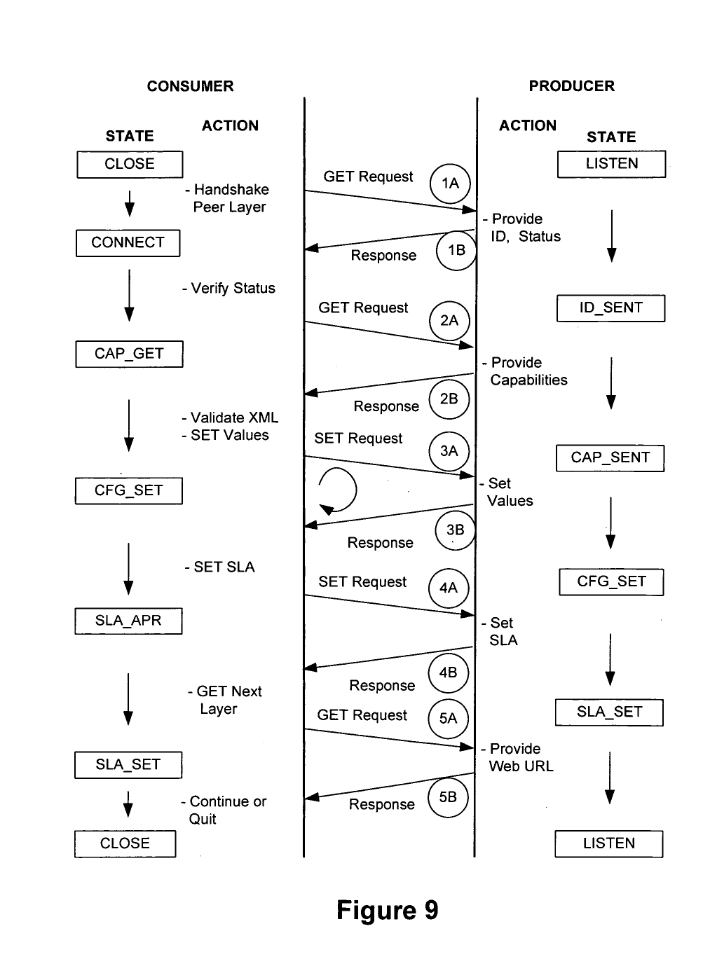

FIG. 9 is a sequence diagram illustrating an exemplary method of step by step communication between peer to peer layers of consumer and producer service negotiation stacks. This communication process is depicted as finite state machine, whose scope may be modified to fine tune the negotiation process. To begin with, the producer layer is in LISTEN state and the consumer layer is in CLOSE state. Consumer initiates a handshake with peer producer layer, by sending a GET request 1A containing its ID, and transitions to CONNECT state. The producer stores consumer ID in its data store and sends a response 1B with its ID, current status, and transitions to ID_SENT state. The producer status may indicate the current condition of the layer including but not limited to LISTEN, DOWN, NEGOTIABLE, NON_NEGOTIATBLE, UNDER_NEGOTIATION, NEGOTIATION_COMPLETE, and UNDER_MAINTENANCE conditions. The consumer layer verifies the status and in case the status is found to be NON_NEGOTIABLE, the consumer layer may quit and transition to CLOSE state. If the status is found to be NEGOTIABLE, then the consumer layer initiates a GET request 2A to its peer producer layer seeking layer specific details and transitions to CAP_GET state. Peer producer layer sets its status to UNDER_NEGOTIATION, and provides a response 2B with a layer specific xml document and the XML Schema it conforms to, and transitions to CAP_SENT state.

Referring to same FIG. 9, consumer layer validates received XML document with applicable XML schema, creates an equivalent object tree with XML path identifiers, forwards the parsed XML data to Web UI, and waits. The Administrator reviews layer details and configures layer parameters. The consumer layer forwards the administrator configured parameters via SET request 3A to peer producer layer and transitions to CFG_SET state. The producer layer verifies if the parameters can be set on the target, and provides a response 3B, with layer configuration, and transitions to CFG_SET state. Steps 3A and 3B continue until the administrator approves the layer configuration as a Service Level Agreement (SLA). Upon the administrator's approval, the consumer layer writes SLA details to data store, issues a SET request 4A, and transitions to SLA_APR state. Peer producer layer sets SLA, which includes updating its data store with SLA details, and provides a response 4B, and transitions to SLA_SET state. The consumer layer requests next layer's web service document URL with a GET request 5A. Peer Producer layer provides response 5B with the URL of the requested layer, and transitions to LISTEN state. Upon receipt of response 5B, the consumer layer transitions to CLOSE state.

Referring to same FIG. 9, the communication between any two peer layers of negotiation stack may be started/stopped, suspended/resumed by setting the layer status to an appropriate value. The communication features may include state persistence that enables reengineering a service at any layer or any step within a layer. The communication features also include version control facilitating service configuration management. Further the communication features between two layers may be modified by customizing the finite state machine.

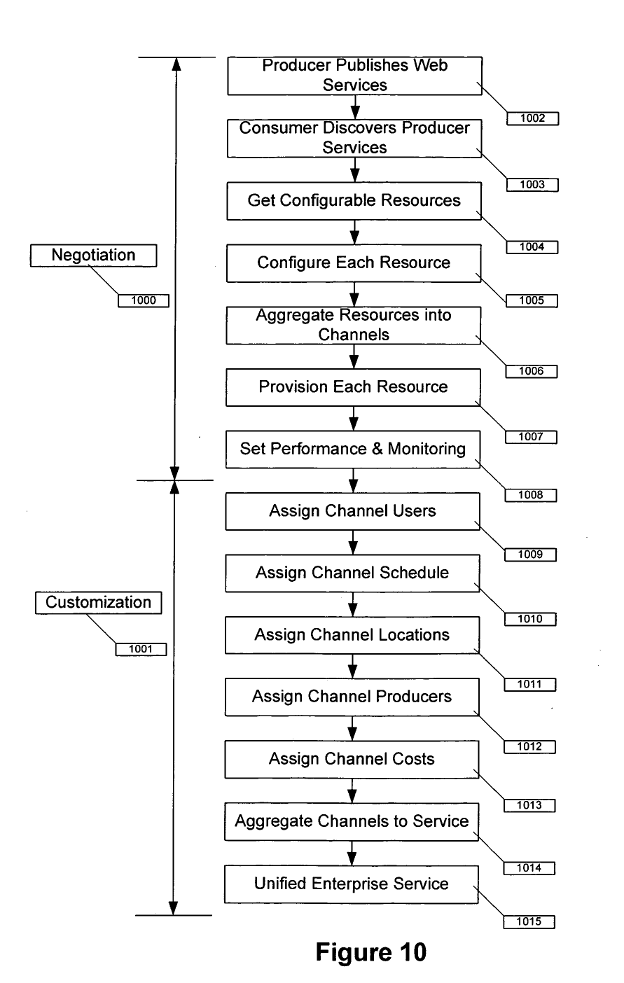

FIG. 10 is a block diagram illustrating the steps for creating a customized IT service. An IT service is created in two stages: negotiation stage 1000 and customization stage 1001. Negotiation is done between peer to peer consumer and producer layers of service negotiation stacks, and customization is done via consumer service customization stack as explained previously while referring to FIG. 5. The negotiation process 1000 starts when the producer publishes web service documents 1002, exposing management capabilities of each layer. Next, Consumer Host layer discovers producer services 1003 published as web service documents via proxies. Next, for a given producer, consumer resource layer gets a list of resources 1004 managed by producer. Next, consumer configuration layer configures the resources 1005 by selecting manageable IT parameters for each resource. Next, consumer resource layer creates an IT channel and aggregates desired resources into it 1006. Next, consumer provisioning layer sets values acceptable by configured IT parameters 1007. Next, consumer notification layer sets monitoring conditions, events, targets, and forwarding rules for provisioned IT parameters 1008. By executing steps 1003, 1004, 1005, 1006, 1007, and 1008 with the active participation of administrator, SLAs are negotiated for each layer, resulting in an IT channel.

Referring to same FIG. 10, customization starts with the consumer's user layer assigning users 1009 to the negotiated IT channel. Users may be enterprise administrators and subscribers. Next, the schedule layer sets usage schedule 1010 for IT channel. Next, the location layer sets the geographical locations 1011 that the channel covers. Next, producer layer assigns producer relevant information 1012. Next, cost layer assigns costs associated 1013 with IT channel. Next, one or more channels are aggregated into IT service 1014 resulting in unified enterprise service 1015. The sequence of negotiation and customization can be chosen by administrator according to preferences in maintaining SLAs of certain layers status quo, while choosing to renegotiate SLAs for other layers or even reengineering part of layers.

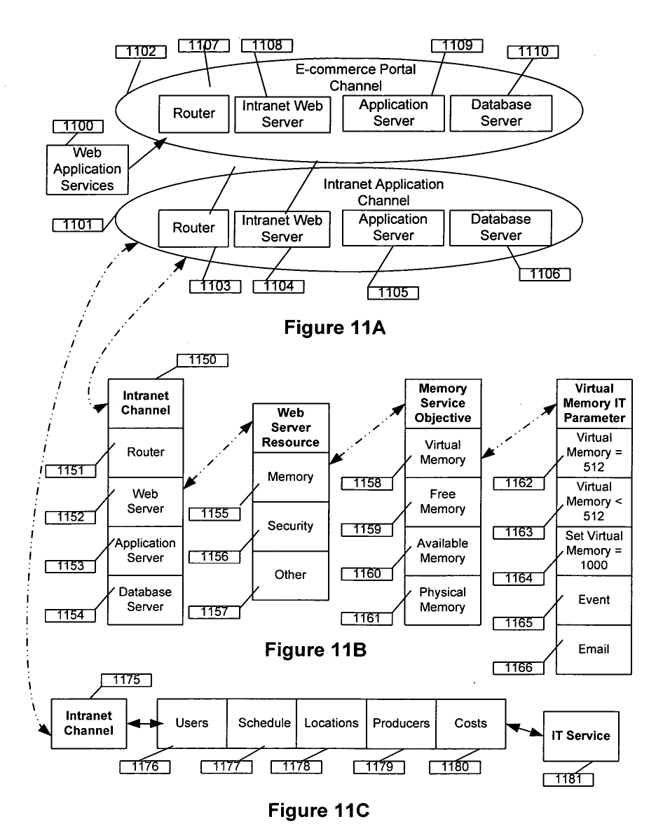

FIGS. 11A, 11B, and 11C are block diagrams illustrating an exemplary method of configuring IT service elements of an enterprise IT Service. FIG. 11A, illustrates an enterprise web service aggregating two IT channels. For instance, a unified enterprise web application service 1100 aggregates two IT channels Intranet Application Channel 1101 and E-Commerce Portal Channel 1102. Intranet Application Channel 1101 aggregates resources: router 1103, intranet web server 1104, application server 1105, and database server 1106. The E-Commerce Portal Channel 1102 aggregates resources: router 1107, internet web server 1108, application server 1109, and database server 1110. The resources of channels are configured with service objectives where each service objective aggregates a number of other managed and monitored IT parameters.

FIG. 11B is block diagram illustrating an exemplary method of configuring, provisioning, and setting up performance monitoring conditions for IT service elements of a channel. For instance, the Intranet Application Channel 1101 referred in FIG. 11A is shown again in FIG. 11B as 1150, aggregating router 1151, intranet web server 1152, application server 1153, and database server 1154. The Intranet Web Server is configured with service objectives: Memory 1155, Security 1156, and some other objective 1157. The Memory service objective is configured with IT parameters: Virtual Memory 1158, Free Memory 1159, Available Memory 1160, and Physical Memory 1161.

Referring to FIG. 11B again, the monitoring condition for Virtual Memory is provisioned at 512 Mega Bytes 1162. If Virtual Memory performance falls below the provisioned value of 512 Mega Bytes 1163, three actions will be taken by the Intranet web server. Set Virtual Memory to a higher value of 1000 Mega Bytes 1164, generate and forward event 1165 to producer service manager, and send an email 1166 to the channel administrator. The IT channel configuration, provisioning, and performance monitoring activities may include a number of IT service elements for resources, hosted services, IT service objectives, parameters, parameter relationships, and parameter monitoring conditions and actions. The scope of IT service elements and extent to which the elements may be configured is influenced by the SLA negotiation process.

FIG. 11C is block diagram, illustrating an exemplary method of customizing the previously negotiated IT channel and aggregating it into a unified enterprise IT Service. For instance, the Intranet Application Channel 1101 referred in FIG. 11A shown again in FIG. 11C as 1175. The Channel is configured with users 1176 consisting of administrators and subscribing users. The administrators may be domain or resource specific administrators and subscribing users may represent departments, organizations, within the enterprise. Next, Schedule options 1177 including but not limited to service duration and service schedule are configured. Next, Locations options 1178 including all the locations that the Channel covers are configured. Next, producer information 1179 is assigned. Next, costs 1180 including but not limited to channel specific set up costs, deployment costs, operating costs, and dismantling costs are assigned. Next, the channel is aggregated into an enterprise IT service 1181. The fully configured and customized enterprise service is now ready for deployment.

When a channel is deployed, resource agents are activated to monitor specific IT service elements conforming to performance SLAs negotiated for that resource. Performance SLAs include but are not limited to IT parameter monitoring conditions, thresholds, action events, event dependencies, and event processing rules. When a monitored IT service element violates specified conditions or thresholds, an event is generated. An event is message consisting of header and body. The header at a minimum contains an event source identifier and an event target identifier, and the body contains an actual message. The event source identifier is a unique path identifier to the IT service element for which the event is being generated. The event target identifier is a unique path identifier to some other IT service element to where the event is targeted. The target may change as the event is forwarded from one portal to another. By default, an event is forwarded from a resource to its producer portal which in turn forwards it to consumer portal via web services. When a service spans across multiple producers, the event is forwarded in a pass through mode from one producer to another until it reaches the consumer.

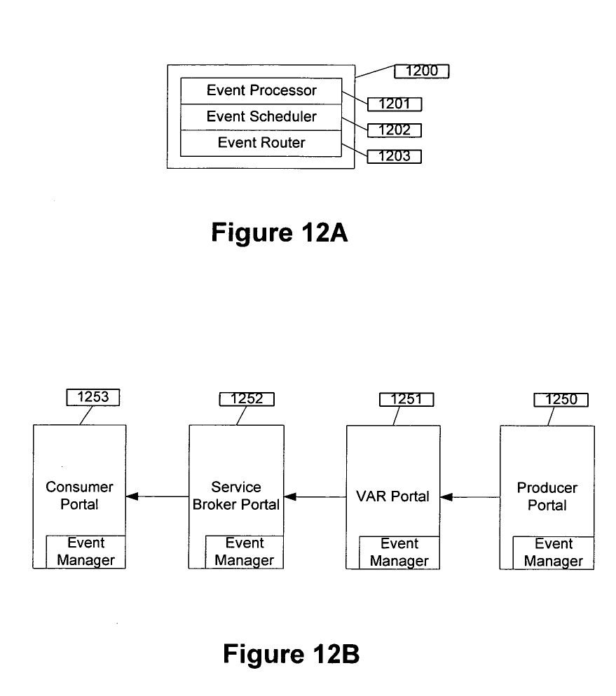

FIGS. 12A and 12B are block diagrams illustrating the components of an event manager and its typical configuration. FIG. 12A is a block diagram illustrating the components of event manager. Event manager 1200 consists of three layers: event processor 1201, event scheduler 1202, and event router 1203. The event processor inspects event, resolves event target or sources to unique path identifiers and vice-versa, and updates the event header. The event scheduler schedules events in conformance with default or custom event scheduling rules. Administrators may reconfigure the scheduler from default to custom event forwarding rules. Event router forwards the scheduled events to targets via web services.

FIG. 12B is a block diagram illustrating typical configuration of event managers on different portals communicating with each other. The capabilities offered by a producer portal 1250 have been enhanced by third party value added reseller 1251. Service broker portal 1252 links the enhanced capabilities to a Consumer Portal 1253. The event managers of portals 1250, 1251, and 1253 are configured to support all the functionalities of event processor, event scheduler, and event router. However the event manager of the service broker portal 1252 is configured for routing events to the next target on a first in first out basis, with minimum functionality support in processing and scheduling activities.

Events are forwarded by applying default or custom event scheduling rules. Default scheduling rules may be based on a combination of event criticality, event priority, and event timestamp. Event criticality is assigned by the resource originating the event on a scale of 1 through 4, where 4 is Normal, 3 is Information, 2 is Warning, and 1 is Severe. Event priority is assigned by the administrator on a scale of 1 through 4, where 4 is Insignificant, 3 is Average Importance, 2 is High Priority, and 1 is Critical. Event priority can be assigned for each IT service element of a service. Event timestamps are inserted in the event header by the event source. Custom scheduling rules allow creating dependencies between events, creating events, merging events, discarding events, and other activities related to event manipulation. Boolean operators like OR, NOR, AND, NAND, XOR, NOT may be used to customize rules. Additional conditional operators like ‘less than’, ‘greater than’, ‘less than or equal’, ‘greater than or equal to’ may also be used. Further, mathematical functions like add, subtract, multiply, divide, percentage, ratios may also be combined with operators to customize rules.

A typical IT infrastructure may have hundreds of resources generating thousands of events every few seconds. These events have to be forwarded to higher layer service elements like IT Channels and Services that are dependent on these resources. When a consumer portal receives an event, it forwards the event(s) to its dependent entities. According to the IT service framework defined by this invention, an IT Service is dependent on its constituent IT Channel(s), which in turn is dependent on mapped IT resource(s). Therefore, by default, an event received by a consumer portal is always forwarded to the dependent IT Channel(s) and Service(s) via web UI. Further, when forwarding events to higher layers, any redundant information is eliminated, thereby reducing possibility of event storms. Also, when events are forwarded to IT elements of higher layers, the event messages may be rewritten to suit the semantics of other layer. The web UI discussed in this invention may provide features to customize event dependencies, map events to messages, and customize event managers.

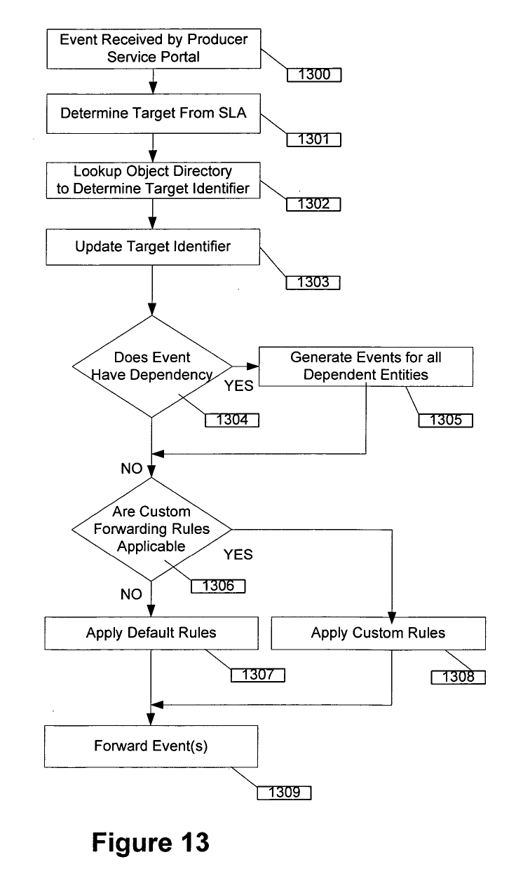

FIG. 13 is block diagram illustrating an exemplary method of processing an event received by a portal. For instance, an event is received by Producer Portal 1300, from its managed resource. The event manager looks up performance SLA to determine the event target 1301. Next, the event manager looks up Object Directory Agent to determine the target identifier 1302. Next, the event manager updates the event header with target identifier 1303. Next, event manager determines if the event has any dependency 1304, and if true, generates new events 1305 targeted towards dependent entities. Next, event manager checks if custom event scheduling rules 1306 are applicable. If custom rules are applicable, event manager applies custom forwarding rules 1308, otherwise applies default rules 1307, and forwards the event(s) to target(s) 1309.

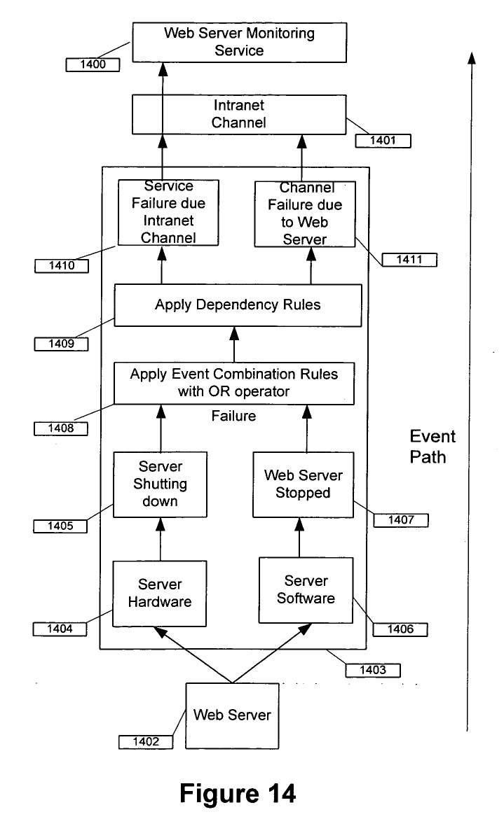

FIG. 14 is a block diagram illustrating an exemplary method of managing events with dependencies. A web Server monitoring service 1400 consists of an Intranet Channel 1401 that is monitoring a web server 1402. If the web Server goes down, it may generate multiple events related to server failure. The consumer portal 1403 receives two events from producer portal. One event from Server hardware 1404 consists of a message: “Server shutting down” 1405 and another event from the Server software 1406 consists of a message: “Web Server stopped” 1407. Since any one of these two events have the same effect on dependent elements, in terms of failure, it is sufficient to notify both the dependent elements: Intranet Channel and Web Server Monitoring Service, with a single failure message. Next, event combination rule with an OR operator is applied 1408 between the events indicating only one event will be forwarded to the higher element. However, the dependency rules 1409 indicate that the event has two dependent elements: Intranet Channel and web Server monitoring service. Therefore an event has to be sent separately to each of the dependent service elements. In order to keep the event message semantics more meaningful to the service element domain, the event message is rewritten. In this instance, event with message “Channel Failure due to Web Server” 1411 is sent to the dependent IT channel and an event with message “Service Failure due to Intranet Channel” 1410 is forwarded to dependent IT service 1400 via Intranet Channel layer 1401. Web UI supports event correlation by grouping events and providing capability to drill down the top layer events all the way through lower layer events, to the root cause. In this instance, the web UI will allow administrator to drill down the service event 1410 to get to channel event 1411, followed by events 1404 and 1406 in random order, all the way down to reach the root cause Web Server 1402.

1. A method of managing information technology services offered from diverse resource management systems in an enterprise network, said method comprising:
configuring enterprise network for managing services by creating a consumer and producer based web service abstraction by
configuring one or more computer systems as Consumer Portals by installing consumer service manager configured for:
(a) supporting consumer web services,
(b) exchanging information with other portals via web services to negotiate and customize service requirements,
(c) processing messages and events received from other portals,
(d) maintaining proxies to other portals,
(e) tagging exchanged data with unique identifiers, and
(f) storing and retrieving data from data stores.
configuring one or more computer systems as producer resource portals by installing producer resource manager configured for:
(a) supporting producer web services,
(b) exchanging information with other portals via web services to negotiate service requirements,
(c) processing messages and events received from other portals,
(d) tagging exchanged data with unique identifiers, and
(e) storing and retrieving data from data stores.
installing and configuring data stores for consumer and producer portals,
configuring a computer system by as a web console, for communicating with Consumer Portal or producer resource portal via secure web based user interface;
offering service capabilities of one or more resource management systems, functioning as producers;
negotiating service requirements between a consumer and one or more producers via web services, with additional capability to negotiate requirements for multiple consumers;
concluding service level agreements that are mutually acceptable between a consumer and one or more producers;
customizing to suit business and administrator specified policies, locations, producers, users, and related criterion;
building a unified enterprise service framework;
processing events in conformance with service level agreements; and
managing enterprise service from web user interface.

2. The method of claim 1, wherein said step of offering is accomplished by:
Customizing XML schemas with data structures and event structures that represent capabilities of service elements for host, resource, configuration, provisioning, and performance layers of producer service negotiation stack,
Creating a web service access class to expose service capabilities of each layer,
Creating web service documents based on web service access class, and
Updating the data store;

3. The method of claim 1, wherein said step of negotiating is accomplished by:
Discovering producer web service documents by consumer,
Creating consumer web service proxy class to the producer web service at each layer of service negotiation: host, resource, configuration, provisioning, and performance,
Establishing peer to peer layer communication between consumer proxy and producer web services,
Exchanging information between consumer and producer service negotiation layers via XML web services, in conformance with a customizable finite state machine that provides features for one peer to determine and exchange other peer's identity, status, capabilities, requirements, and any other useful data, and
Eliminating possible data exchange conflicts between service elements having same names by creating unique path identifiers to each node of the xml data exchanged and by maintaining unique path identifiers between different portals, producers, consumers, and service domains, utilizing the services of Object Directory Agent;

4. The method of claim 3, wherein said step of exchanging is accomplished by:
Providing enterprise administrator complete access to review capabilities and modify requirements during any state of negotiation process via web user interface;
Discovering and exchanging consumer, producer, and service details via host layer,
Discovering resources managed by producers irrespective of location via resource layer, choosing desired resources by consumer, aggregating chosen resources in an abstract service element: information technology channel,
Configuring resource specific service elements via configuration layer: service objectives, IT parameters, parameter relationships, and monitoring conditions,
Provisioning values or a range of values acceptable by configured service elements, via provisioning layer, and
Providing performance monitoring conditions, thresholds, events, event dependencies, event forwarding rules, and other event management details for provisioned resource service elements, via Performance layer;

5. The method of claim 1, wherein said step of concluding is accomplished by:
Accepting mutually negotiated requirements and capabilities for each layer by administrator as service level agreements,
Aggregating all layer specific service level agreements in to the channel, and
Storing the service level agreements of the channel in both producer and consumer data stores;

6. The method of claim 1, wherein said step of customizing is accomplished by:
Assigning information by the enterprise administrator to the channel at each layer of service customization stack by:
Classifying users as administrators and subscribers, mapping users to the channel, and assigning user authentication and authorization policies to the channel,
Specifying usage schedules, covered locations, and participating producers to the channel,
Specifying options to track setup, deployment, operational, and reengineering costs to the channel,
Specifying any other customizable data to the channel under other category of service customization stack, and
Storing the customized information in consumer data store;

7. The method of claim 1, wherein said step of building is accomplished by:
Aggregating one or more customized channels into an enterprise IT service,
Performing checks to ensure all the service elements are aggregated according to the IT service framework, wherein a service aggregates one or more channels, a channel aggregates one or more resources which may be distributed across different locations and managed by diverse management systems, a resource aggregates one or more service objectives, and a service objective aggregates one or more IT parameters described by attribute-value pairs, governed by parameter monitoring conditions, and parameters having interrelationships,
Storing the enterprise IT service data in data store;

8. The method of claim 1, wherein said step of processing is accomplished by:
Forwarding events received by producer portal from its managed resources or systems, to the consumer portal directly or via one or more intermediate portals functioning as brokers or value added resellers,
Forwarding events received by consumer portal to web user interface, where events may be directed to higher layer service elements like channel or service, and
Storing and retrieving event data into/from data store via event manager;

9. The method of claim 8, wherein said step of forwarding is accomplished by:
Inspecting events by event manager,
Remapping targets when events are forwarded between different portals or domains or service elements,
Applying event redundancy checks to eliminate events with duplicate information,
Creating new events to fulfill dependencies and remapping event messages to suit dependent domain semantics,
Scheduling events, and
Routing scheduled events to the next target;

9. The method of claim 1, wherein said step of managing is accomplished by:
Providing administrators web user interface access to input data, view displayed data, and process data to:
Create enterprise service by driving service negotiation process, customizing services, customizing event processing rules, and event dependencies,
Correlate events with drill down capability to locate root cause,
Maintain portals by backing up and retrieving data and performing switchovers between portals,
Manage users authentication and authorization, and
Other substantial features required to accomplish service management;

10. The claim methods 1 through 9 are accomplished through web based communications.
